(19) United States
(12) Patent Application Publication
(10) Pub. No.: US 2007/0121888 A1
(43) Pub. Date: May 31, 2007

(54) Server apparatus

(75) Inventors: Fumikazu Matsukawa, Ome-shi (JP); Shigeru Fukazawa, Hachioji-shi (JP); Yasumasa Sasaki, Tachikawa-shi (JP); Koji Shima, Sagamihara-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/524,878

(22) Filed: Sep. 22, 2006

(30) Foreign Application Priority Data
Sep. 22, 2005 (JP) 2005-276077

(51) Int. Cl. H04M 7/00

(52) U.S. Cl. 379/219

(57) ABSTRACT

According to one embodiment, a server apparatus includes a communication management memory which stores a communication management table, in which the data IDs are associated with state information showing communication connection states among the plurality of data terminals, when the communication connections among the plurality of the data terminals are established, a determining unit to refer the communication management table, based on the data IDs associated with the telephone IDs included in the call information event in receiving the call information event and determine presence/absence of a change in the communication connection states among data terminals corresponding to the data IDs based on the reference result, and a controller to update state information corresponding to the data IDs in the communication management table and execute communication connections/disconnections among the relevant data terminals based on the updated state information.

### CROSS-REFERENCE TO RELATED APPLICATIONS

This application is based upon and claims the benefit of priority from Japanese Patent Application No. 2005-276077, filed Sep. 22, 2005, the entire contents of which are incorporated herein by reference.

### BACKGROUND

1. Field

One embodiment of the invention relates to, for instance, a server apparatus of a visual communication system (hereinafter referred to as VCS), in which the server apparatus is connected to a telephone exchange apparatus via a communication path so as to enable treating a video signal, computer data, etc. in addition to a voice signal.

2. Description of the Related Art

In an office and a business institution, a private network system has been used. The private network system installs, for instance, telephone sets in a telephone exchange apparatus such as a private branch exchange (PBX) and a key telephone apparatus as extension terminals, and exchange-connects between the extension terminals and an external communication network such as a public network and among extension terminals by means of the telephone exchange apparatus to enable telephone conversations.

Recently, a system in which a server with a data terminal such as a television telephone terminal and a personal computer is connected to the telephone exchange device via a transmission path and makes a voice communication system using the telephone exchange device operate together with a data communication system using the server has been proposed (for instance, Jpn. Pat. Appln. KOKAI Publication 10-215322).

Meanwhile, a side-by-side shape system of the forgoing telephone exchange apparatus and the server, it is strongly desired for a service to constitute a television conference by operating data communication connections among data terminals together with calling states of the telephone sets. However, the forgoing system requires a caller ID when a call is made from the public network to the telephone terminal, and displays information related to the caller ID to a corresponding data terminal. And as to the VCS providing an additional service such as a television conference, it ahs been still in an examination stage and has not been established up to now.

By the way, to achieve the VCS, it becomes necessary to examine the following measures.

That is to say, the VCS has a general control constitution in that a VCS server receives a call information event (originating side device information, incoming side device information) transmitted from the telephone exchange device when the calling states among telephone terminals connected to the telephone exchange, it analyzes the connection states among telephone terminals based on the call information event, and it instructs to start/end visual communications to data terminal associated with the telephone terminal on the basis of the connection states.

However, only control lines connecting among the VCS server and a plurality of data terminals, the control lines are shared with a number of data terminals, therefore, processing loads and traffic loads become large due to a use time zone, a use environment, etc., and it results in occurrences of errors sometimes in establishing sessions among data terminals.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary schematic configuration view showing a VCS regarding a first embodiment of the present invention;

FIG. 2 is an exemplary block diagram showing a functional configuration of a VCS server shown in FIG. 1;

FIG. 3 is an exemplary view showing an example of a stored content in a connection information management table shown in FIG. 2;

FIG. 4 is an exemplary view showing an example of a stored content in an extension terminal-VC associating table shown in FIG. 2;

FIG. 5 is an exemplary view showing an example of a stored content in a session information management table shown in FIG. 2;

FIG. 6 is an exemplary schematic sequence view showing transmitting/receiving operations of information among extension terminals, a main device, a VCS server and data terminals in executing visual communication control in the first embodiment;

FIG. 7 is an exemplary flowchart showing a control procedure of the VCS server in executing the visual communication control in the first embodiment;

FIG. 8 is an exemplary view for explaining an aspect of generating a control signal so as to transmit it to the corresponding data terminal by the VCS server in the first embodiment;

FIG. 9 is an exemplary flowchart showing a control processing procedure of a VCS server in executing a visual communication control processing as a second embodiment of the present invention; and

FIG. 10 is an exemplary view for explaining an aspect of generating a control signal so as to transmit it to the corresponding data terminal by a VCS server in a second embodiment.

### DETAILED DESCRIPTION

Various embodiments according to the invention will be described hereinafter with reference to the accompanying drawings. In general, according to one embodiment of the invention, a server apparatus which receives call information event including telephone IDs specifying a plurality of telephone terminals to which call connections performed thereto, and operates communication connections at a plurality of data terminals, being associated with the telephone IDs of the plurality of telephone terminals, respectively, and also assigned data IDs, together with the call connections, comprising: a communication management memory which stores a communication management table, in which the data IDs are associated with state information showing communication connection states among the plurality of data terminals, when the communication connections among the plurality of the data terminals are established; a determining unit to refer the communication management table, based on the data IDs associated with the telephone IDs included in the call information event in receiving the call information event and determine presence/absence of a change in the communication connection states among data terminals corresponding to the data IDs based on the reference result; and a controller to update state information corresponding to the data IDs in the communication management table and execute communication connections/disconnections among the relevant data terminals based on the updated state information when it is determined by the determining unit that the communication connection states are changed.

### FIRST EMBODIMENT

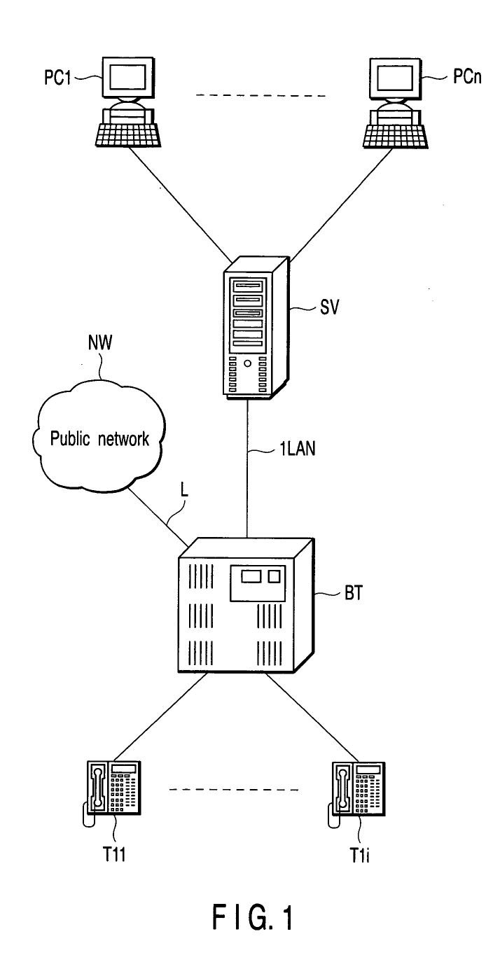

FIG. 1 is the exemplary schematic configuration view showing the VCS regarding the first embodiment of the present invention.

The system, as shown in FIG. 1, has a main apparatus BT and a VCS server SV, and connects between the main apparatus BT and the VCS server SV via a local area network (LAN) 1.

The main apparatus BT houses extension terminals T11-T1i via extension lines. The main apparatus BT1 is connected to a public network NW via a central office line L. The main apparatus BT executes exchange processing among extension terminals T11-T1i with one another or among the extension terminals T11-T1i and the public network NW.

The VCS server SV houses a plurality of data terminals PC1-PCn via an IP network. Each of these data terminals PC1-PCn is consists of a general-purpose personal computer and operates in association with each extension terminal T11-T1i, respectively.

The foregoing VCS server SV executes an additional function to the main apparatus BT, and for instance, processes media information such as a video.

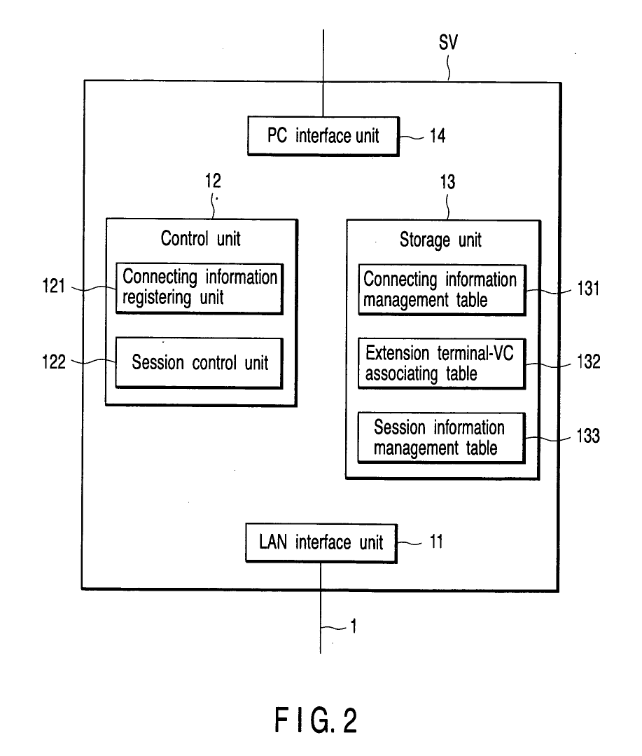

FIG. 2 is the block diagram showing the functional configuration of the VCS server SV.

The VCS server SV has a LAN interface unit 11, a control unit 12, a storage unit 13 and a PC interface unit 14. Among these units, the LAN interface unit 11 performs interface processing to and from the LAN 1.

The PC interface unit 14 performs interface processing to and from the data terminals PC1-PCn.

The storage unit 13 stores routing information, etc., necessary for connection control by the control unit 12. Further, the storage unit 13 is provided with a connection information management table 131 (hereinafter referred to as table 131), an extension terminal-VC associating table 132 (hereinafter referred to as table 132), and a session information management table 133 (hereinafter referred to as table 133).

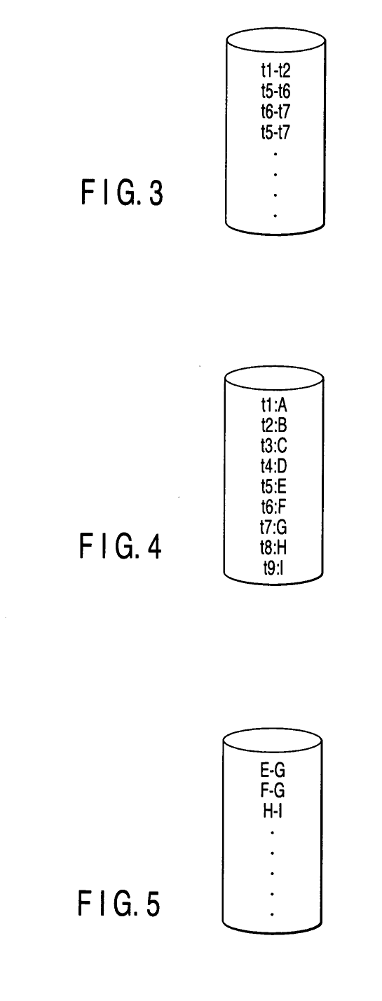

The table 131, as shown in FIG. 3, stores data showing correspondence relationships among each telephone number (telephone ID) of the extension terminals T11-T1i and state information showing the connection states. Symbols ti-t9 indicate each telephone ID of the extension terminals T11-T19, respectively. Here, to simplify the explanation, the extension terminals T11-T1i are represented by the extension terminals T11-T19.

The table 132, as shown in FIG. 4, stores data indicating correspondence relationships among the extension terminals T11-T1i and the data terminals (PCs) PC1-PCn. In FIG. 4, characters A-I are each data ID of the data terminals PC1-PC9, respectively.

As shown in FIG. 5, the table 133 stores information showing session states among data terminals PC1-PC9.

On the other hand, the control unit 12 has a connection information registration unit 121 (hereinafter referred to as registration unit 121) and a session control unit 122 as new functions regarding the present invention in addition to state management of the data terminals PC1-PCn and a control function regarding coordinated operations among the data terminals PC1-PCn and the extension terminals T11-T1i.

The registration unit 121 determines, for instance, that a telephone conversation is made between the extension terminal T15 and the extension terminal T16 by analyzing a call information event notified from the main apparatus BT to add sate information “t5-t6” to the table 131.

The session control unit 122, for instance, when receiving a call information event showing an interruption telephone conversation of the extension terminal T17 to the extension terminal T16 from the main apparatus BT during a telephone conversation between the extension terminals T15 and T16, adds state information “t6-t7” to the table 131. The session control unit 122 then reads out the fact that the extension terminal T16 is associated with the data terminal PC6 and the extension terminal T17 is associated with the data terminal PC7 from the table 132 on the basis of the updated state information to retrieve the session state of the data terminals PC6 and PC7 from the table 133. For example, in the case of start a telephone conversation from now, since the data terminals PC6 and PC7 have not started a session, the session control unit 122 controls so as to start the session of the data terminals PC6 and PC7. When the session of the date terminals PC6 and PC7 has been established, the session control unit 122 updates the stored content in the table 133.

Next, operations of the VCS configured as given above will be described.

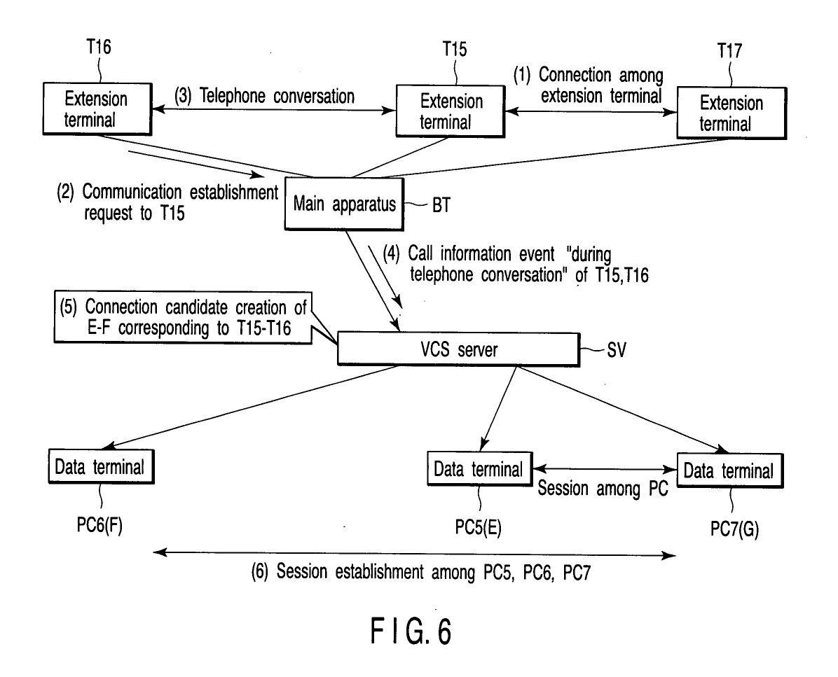

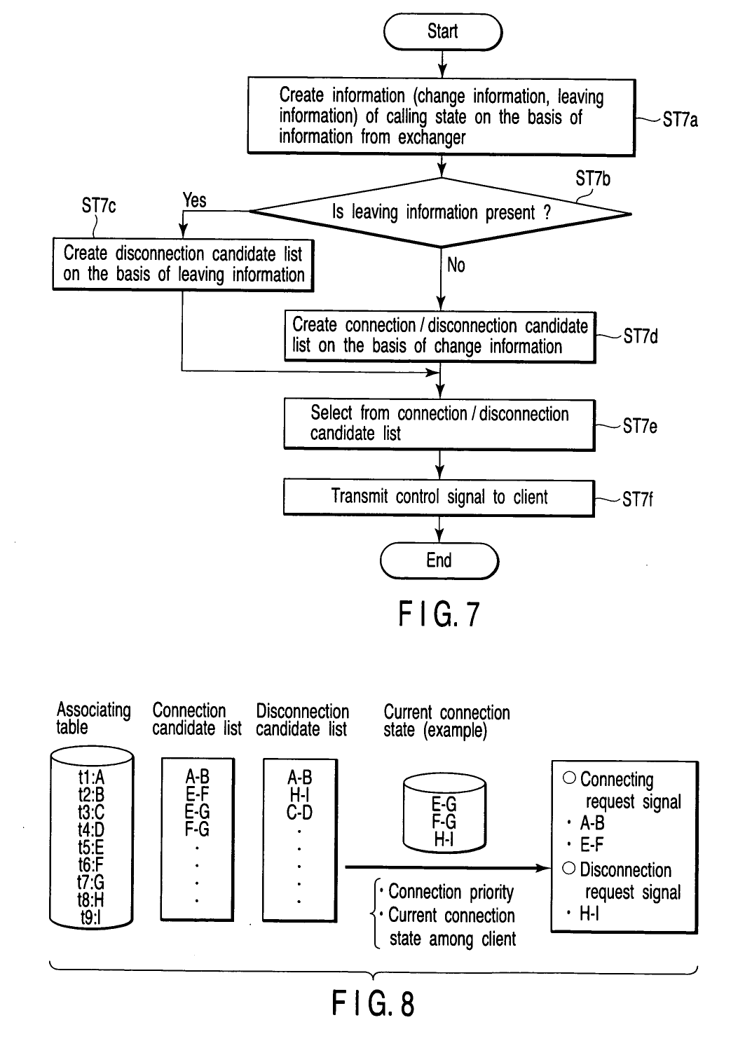

FIG. 6 is a sequence view showing operations in the case of connecting between the extension terminal T15 and the extension terminal T16 during the telephone conversation between the extension terminals T15 and T17 and between the extension terminals T16 and T17. FIG. 7 is a flowchart showing a control processing procedure of the VCS server in the control processing procedure given above.

Now, it is presumed that a telephone conversation is made between the extension terminals T15 and T17 and between the extension terminals T16 and T17 [FIG. 6 (1)].

In this state, it is supposed that a user performs an operation to require a telephone conversation to the extension terminal T15 by means of the extension terminal T16 [FIG. 6(2)]. Then, the extension terminal T16 transfers the request signal to the main apparatus BT. When receiving the communication establishment request signal, the main apparatus BT calls out the extension terminal T15 to be an incoming call destination while maintaining a communication link with the extension terminal T17. When the extension terminal T15 responds to this calling out, the main apparatus BT established a communication link between the extension terminal T15 and the extension terminal T16 [FIG. 6(3)], and transmits the call information event showing the fact of being during a telephone conversation between the extension terminals T15 and T16 to the VCS server SV [FIG. 6(4)].

When receiving the call information event, the VCS server SV firstly determines whether or not the telephone ID (t6) of the extension terminal T16 included in this call information event is present in the table 131. Here, the telephone ID (t6) being present, the VCS server SV associates the extension terminal 15 with the extension terminal T16 to store them in the table 131 [FIG. 6(5)].

As the same time, the server SV creates change information and leaving information of calls (block ST7a). As for information patterns of the calls, new generation of a call accompanied by a new telephone conversation start, a change in a sate of a call accompanied by a reservation and leaving of a terminal, and finish of a call accompanied by the termination of the telephone conversation are possible cases. The change information of the call means an ID of a call with such a change made thereto. The leaving information means a combination of an ID of a terminal which has left from a certain call and an ID of a call from which the terminal has left.

Next, the VCS server SV checks whether or not the leaving information is included in the information of the generated calling state (block ST7b). The check is conducted because, in the case of a mere start and a reservation of a telephone conversation, the leaving terminal is not present and the leaving information is not generated sometimes. If the leaving information is included in the information, the VCS server SV creates a disconnection candidate list with a combination of two becoming candidates of disconnections of visual communications among clients stored therein on the basis of the leaving information as shown in FIG. 8 (block ST7c). As for a premise of generating the disconnection candidate list, terminals which are associated with the data terminals PC1-PCn and registered in the table 132 in advance are set as objects to be processed. The policies to which the creation of the disconnection candidate list follows are:

(1) If there are a plurality of leaving terminals to the same call, the terminals should be disconnected with one another

(2) For a call with terminals have left therefrom, the terminal to which a call belongs now and the leaving terminals should be disconnected with each other.

And the VCS server SV adds the combination of the terminals matching to the policies to the list as the candidates. If the leaving information is not present, the VCS server SV shifts from the block ST7b to a block ST7d, whereat it creates a connection candidate list storing the combination of the two becoming the connection candidates and the disconnection candidate list of the visual communications among clients on the basis of the change information of the calls. Here, the VCS server SV acquires information of a current call (terminal to which call belongs, and its state) from the table 131 with the connection information of the calls stored therein on the basis of the IDs of the changed calls. The policies to which the creation of the two lists follows are:

(1) If terminals in telephone conversation states for the call are present, the terminals should be connected in accordance with each combination

(2) If terminals in reservation states for the call are present, the terminals and the opponent terminals should become candidates of a disconnection (in the case of disconnecting visual communication in reservation state).

And the VCS server SV adds the combination of the terminals matching to the policies to the connection candidate list and the disconnection candidate list as the candidates.

In the above-described example, the VCS server SV adds combinations “E-F” of the data terminals PC5 “E” and PC6 “F” associated with the extension terminals T15 and T16 to the connection candidate list.

After completing the list creation, the VCS server SV selects combinations from the lists (block ST7e).

The lists created in the aforementioned blocks are still candidates, and the VCS server SV selects a combination for actually transmitting control signals to the data terminals PC1-PCn from the connection candidate list and the disconnection candidate list. References for the selection are:

(1) The combinations present in both the connection candidate list and the disconnecting candidate list should be put a high priority on a connection (in FIG. 8, combination of “A-B” is corresponding)

(2) If visual communication connections among clients have been already present now in the combinations in the connection candidate list, the combinations should be removed from the candidates (in FIG. 8, combinations “E-G” and “F-G” are corresponding)

(3) If the visual communication connection among clients has not been present now in the combinations in the disconnection candidate list, the combination should be removed (in FIG. 8, combination “C-D” is corresponding).

According to the result given above, for the combinations remaining in the candidate lists, the VCS server SV transmits control signals to the corresponding data terminals PC5 and PC6 to establish the session between the data terminals PC5 and PC6 [block ST7f: FIG. 6(6)].

As described above, in the first embodiment, the storage unit 13 is provided with the table 133 showing the correspondence relationships among the data IDs of the data terminals PC5 and PC6 which are respectively associated with the extension terminals T15 and T16, being included in the call information event from the main apparatus BT and being performed call connections, and state information showing the session state between the data terminals PC5 and PC6. Then, the VCS server SV refers to the table 133 on the basis of the data IDs which are associated with telephone IDs included in the call information event from the main apparatus BT to determine the presence/absence of the change in the session state between the data terminals PC5 and PC6 corresponding to the data IDs, when the call information event is received. Further, the VCS server SV updates the state information “E-F” corresponding to the data IDs in the table 133 when it is determined that the session state has changed, and it executes the communication connection/disconnection between the corresponding data terminals PC5 and PC6 based on the updated state information.

Accordingly, since the VCS server SV transmits the control signal to execute the communication connection/disconnection only to the data terminals PC5 and PC6 of which the communication connection/disconnection ate determined to be necessary, it can prevent a situation in which control signals are transmitted to occur a lot of errors, thereby it can reduce processing and traffic load.

The aforementioned first embodiment makes it possible to select a large number of the data terminals PC1-PCn as the connection candidates and also as the disconnection candidates, remove the combinations of the data terminals PC5 and PC7 “E-G” and the data terminals PC6 and PC7 “F-G” from the connection candidate list, and also remove the combinations of the data terminals PC3 and PC4 “C-D” from the disconnection candidate list. Therefore, the server apparatus of the first embodiment can further enhance the efficiency in deciding the combinations of data terminals between the PC1 and PC2 and between the PC5, PC6 to be the communication/disconnection.

### SECOND EMBODIMENT

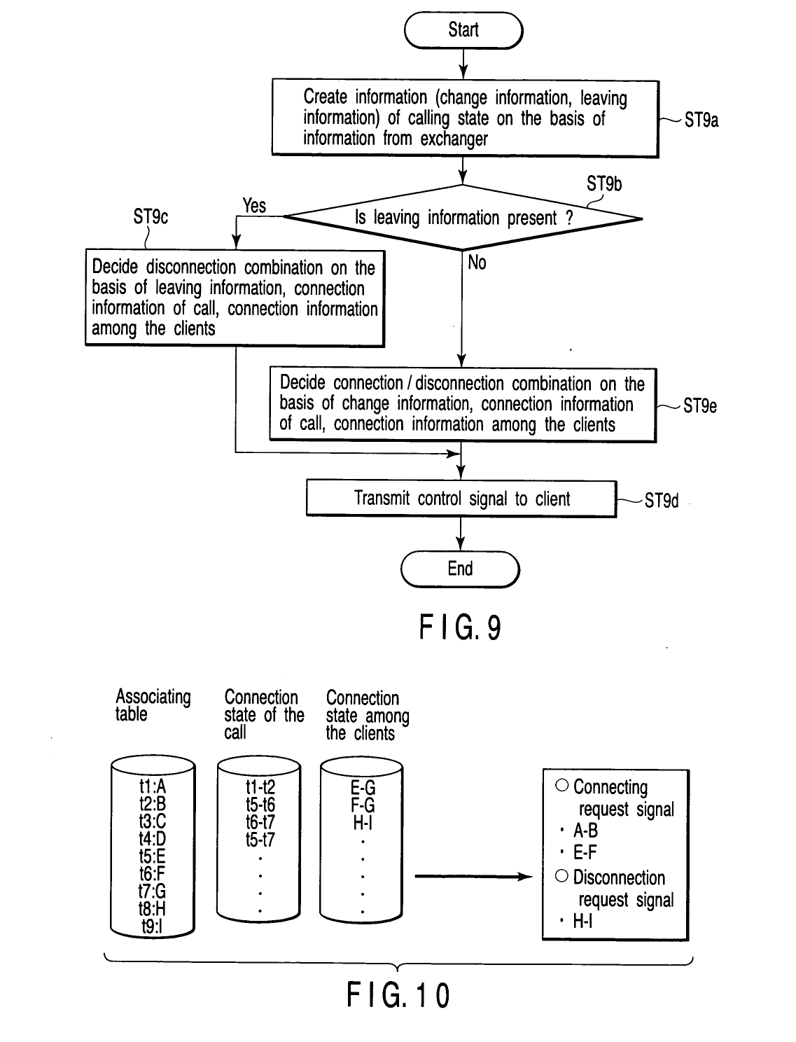

FIG. 9 is the flowchart showing the control processing procedure of the VCS server in executing the visual communication control processing as the second embodiment of the present invention, and FIG. 10 is the view showing an aspect in which a control signal is generated in the control processing procedure.

At first, the VCS server SV receives information, as an event, relating to a call from the main apparatus BT, and performs registrations/deletions to/from the table 131, based on it. And simultaneously, the VCS server SV creates the change information and leaving information of the call (block ST9a).

Next, the VCS server SV checks whether or not the leaving information is included in the created information of the calling state (block ST9b). This is because that a leaving terminal is not present and the leaving information is not created sometimes, when the calling state is merely the start or reservation of the telephone conversation.

Then, if the leaving information is included (YES, in block ST9b), the VCS server SV acquires connection state information of the current call from the table 131 with the connection information of calls stored therein based on the ID of the call from which the terminal is left. After this, based on the telephone IDs of the leaving extension terminals T18 and T19, the VCS server SV acquires the current information about visual communication connection state among the clients from the tables 132 and 133 (block ST9c). The VCS server SV compares the information to decide a combination of the terminals to be disconnected, and transmits the control signal for the disconnection requests to the relevant data terminals PC8 and PC9 (block ST9d).

On the contrary, if the leaving information is not included (NO, in block ST9b), the VCS server SV shifts from the block ST9b to the block ST9e, whereat it acquires connection state information of the current call from the table 131 based on the call IDs of which the states are changed. After this, the VCS server SV acquires information of the current visual communication connection states among the clients from the tables 132 and 133 based on the telephone IDs of the extension terminals T11-T1i now belonging to the calls. With comparison the information, the VCS server SV decides the combination of the two terminals to be connected and disconnected to transmit the control signals of the connection requests to the clients.

As described above, in the second embodiment, the VCS server SV can determines the data terminals PC1-PCn to be connected/disconnected with a simple procedure by using the information stored in the tables 131 and 133.

### OTHER EMBODIMENT

Other than this, it is possible to make a variety of modifications to implement the configuration and kind of the VCS server, the kind of the telephone exchange device (not only main apparatus, but PBX is usable), kinds of the extension terminals, kinds of the data terminals, stored contents of a variety of table, session control method among data terminals, etc., without departing from the aspect of the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A server apparatus which receives call information event including telephone IDs specifying a plurality of telephone terminals to which call connections performed thereto, and operates communication connections at a plurality of data terminals, being associated with the telephone IDs of the plurality of telephone terminals, respectively, and also assigned data IDs, together with the call connections, comprising:
a communication management memory which stores a communication management table, in which the data IDs are associated with state information showing communication connection states among the plurality of data terminals, when the communication connections among the plurality of the data terminals are established;
a determining unit to refer the communication management table, based on the data IDs associated with the telephone IDs included in the call information event in receiving the call information event and determine presence/absence of a change in the communication connection states among data terminals corresponding to the data IDs based on the reference result; and
a controller to update state information corresponding to the data IDs in the communication management table and execute communication connections/disconnections among the relevant data terminals based on the updated state information when it is determined by the determining unit that the communication connection states are changed.

2. The server apparatus according to claim 1, wherein
the communication management memory stores a connection candidate list showing each data ID of the plurality of data terminals to become connection candidates and a disconnection candidate list showing each data ID of the plurality of data terminals to become disconnection candidates; and
the controller adds/deletes the relevant data IDs in the connection candidate list and the disconnection candidate list, and executes the communication connection/disconnection among the relevant data terminals based on the connection candidate list and the disconnection candidate list to which the addition/deletion are performed to/from, when it is determined by the determining unit that the communication connection states are changed.

3. The server apparatus according to claim 1, further comprising:
a telephone management memory which stores a telephone management table in which the telephone IDs included in the call information event from the telephone exchanger are associated with state information showing call connection states among the plurality of telephone terminals when call connections among the plurality of telephone terminals are established, wherein
the determining unit refers to the telephone management table, based on the telephone IDs included in the call information event in receiving the call information event to determine presence/absence of a change in call connection states among data terminals corresponding to the telephone IDs, updates state information corresponding to the telephone IDs in the telephone management table when the call connection states are changed, and determines presence/absence of a change in communication connection states among the relevant data terminals by comparing the updated telephone management table with the communication management table.

4. The server apparatus according to claim 1, wherein
the determining unit determines whether or not leaving information including data ID to become a leaving object is present in the relevant call information in receiving the call information event; and
the controller transmits disconnection requests to the relevant plurality of data terminals, when it is determined that the leaving information is included in the call information event.
